(19) United States
(12) Patent Application Publication
(10) Pub. No.: US 2006/0227991 A1
(43) Pub. Date: Oct. 12, 2006

(54) Combination wind screen and microphone shock mount

(76) Inventor: Manfred Klemme, Vista, CA (US)

Correspondence Address: MARCIA A. DEVON;DEVON & ASSOCIATES, 400 OCEANGATE BLVD., SUITE 800, LONG BEACH, CA, 90802, US

(21) Appl. No.: 11/101,339

(22) Filed: Apr. 7, 2005

(51) Int. Cl. H04R 11/04

(52) U.S. Cl. 381/363

(57) ABSTRACT

A combination windscreen and shock-absorbing mount for a microphone is disclosed. The mount includes a clamp support comprising a base, a manual clamping means, and a pivot platform. A support bracket is attached to the pivot platform by an attachment means, and further includes a windscreen support mount and at least one microphone support mounting arm. An elastomeric shock-absorbing microphone support is adapted for lockable engagement with each microphone support mounting arm of the support bracket, and further includes a microphone aperture therethrough for receiving and frictionally retaining the microphone. A windscreen support is adapted for lockable engagement with the windscreen support mount of the support bracket. The windscreen support includes a ring with an aperture at least partially therethrough. The ring frictionally retains a windscreen, which is comprised of a generally elongated body with a closed end and an open end. The body further includes a microphone aperture therethrough for receiving and frictionally retaining the microphone. A windscreen sleeve is included for covering the body of the windscreen and is made from a pliant cloth or fur-like material to further absorb wind noise, considerably reducing the amount of wind noise reaching the microphone.

### FIELD OF THE INVENTION

This invention relates to microphones, and more particularly to a shock absorbing wind screen microphone mount.

### DISCUSSION OF RELATED ART

A microphone is sensitive to wind noise and mechanical vibration caused by shocks or jolts to a boom or stand supporting the microphone. Various devices in the prior art have been designed to reduce both wind noise and shock-related noise. For example, U.S. Pat. No. 6,459,802 to Young discloses an elastomeric band arrangement for supporting a microphone away from a rigid support stand; U.S. Pat. No. 4,991,220 Wolf discloses an elastic support member for a microphone; and U.S. Pat. No. 4,514,598 to Plice discloses a shock-mounting apparatus for supporting a microphone with elastic bands. The prior devices are not well-suited for use with windscreens which tend to be somewhat bulky. The prior devices provide little room around which to mount a windscreen. Consequently, while the prior shock-absorbing mount designs may reduce shock-related noise, prior designs have not been conducive to the use of windscreens.

Other devices in the prior art, such as U.S. Pat. No. 5,444,790 to Kogen and British Patent 2,208,577 to Gozzard , disclose windscreen devices that reduce noise in microphones caused by wind. The most effective of such devices typically use a great number of small-diameter flexible filaments, or fur-like materials, to arrest wind noise. However, such an arrangement, while effective against unwanted wind noise, is by its very nature bulky and somewhat voluminous, and therefore cannot be used in combination with existing shock-absorbing mounts.

Therefore, there is a need for an inexpensive shock-absorbing microphone mount that also includes a windscreen arrangement for reducing wind noise. The device should be well-suited for use outdoors, and with existing booms and other mechanical microphone supports. Further, the microphone mount should be easy to assemble and adjust to any desired microphone orientation. The present invention accomplishes these objectives.

### SUMMARY OF THE INVENTION

The present device is a combination windscreen and shock-absorbing mount for a microphone. The mount includes a clamp support comprising a base, a clamp, and a pivot platform, and is supported by a boom. As such, the angle of the pivot platform with respect to the boom may be readily manually adjusted.

A support bracket is attached to the pivot platform by a pivot platform attachment means, and further includes a windscreen support mount and at least one microphone support mounting arm. A microphone support is adapted for lockable engagement with each microphone support mounting arm of the support bracket, and further includes a microphone aperture therethrough for receiving and frictionally retaining the microphone.

A windscreen support is adapted for lockable engagement with the windscreen support mount of the support bracket. The windscreen support includes a ring with an aperture at least partially therethrough. The ring is bonded to the windscreen, which is comprised of a generally elongated body with a closed end and an open end. The body further includes a microphone aperture therethrough for receiving and frictionally retaining the microphone. A windscreen sleeve is included for covering the body of the windscreen. The sleeve is made from a pliant cloth or fur-like material lined with a high density woven fabric which serves as a barrier to further absorb wind noise, considerably reducing the amount of wind noise to the microphone.

The present device is an inexpensive shock-absorbing microphone mount that also includes a windscreen arrangement for reducing wind noise. The present device is well-suited for use outdoors, and with existing booms and other mechanical microphone supports. Further, the present device is relatively easy to manufacture and extremely simple to assemble and use, being quickly adjustable to any desired microphone orientation on the boom or other microphone support. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of the invention, illustrating a mount for a microphone; and

FIG. 2 is an exploded view of the invention, illustrating in more detail the components of the invention.

### DETAILED DESCRIPTION OF THE PREFERRED EMBODIMENT

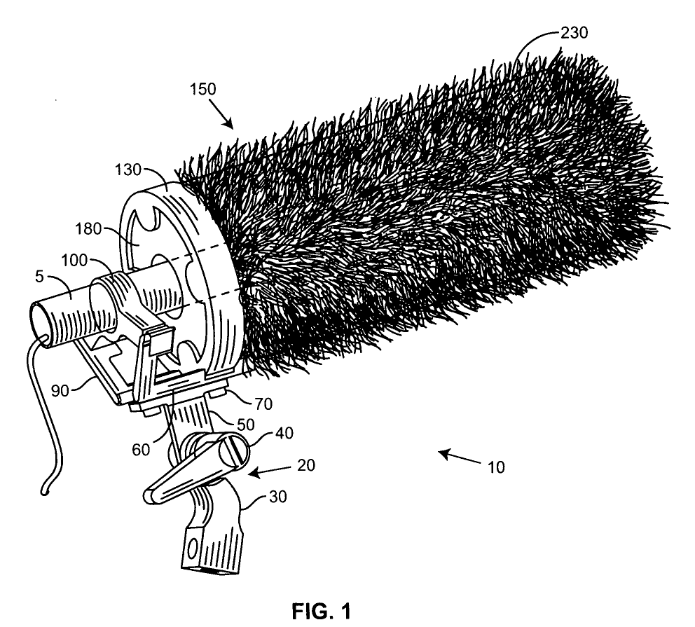

With respect to the drawings, FIG. 1 illustrates a combination windscreen and shock-absorbing mount 10 for a microphone 5. The mount 10 includes a clamp support 20 comprising a base 30, a clamp 40, and a pivot platform 50, and is supported by a boom (not shown), and attached thereto in a conventional fashion known in the art. The base 30 comprises rigid materials suitable for outdoor use, such as a machined aluminum.

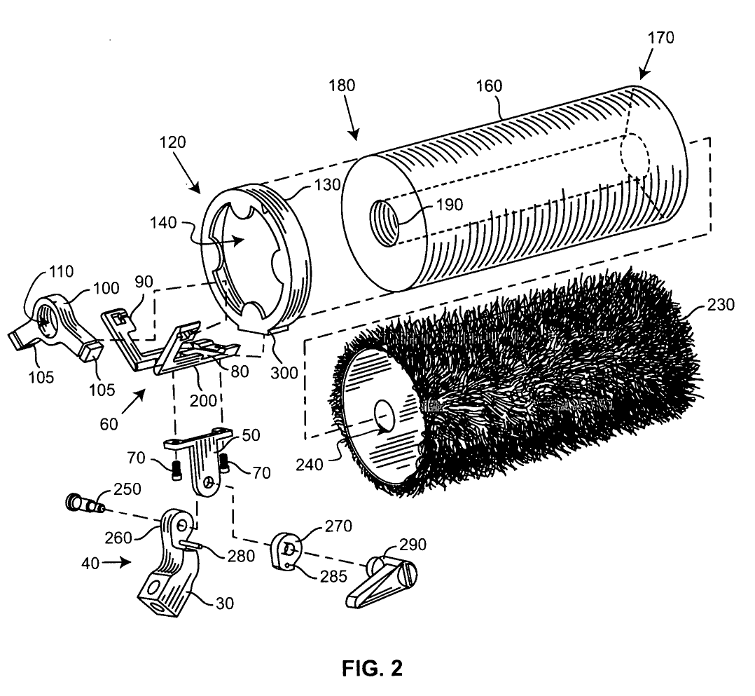

The clamp support 20 preferably includes a threaded pivot pin 250 (FIG. 2) traversing a first clamp member 260. First clamp member 260 is attached to the base 30, a second clamp member 270, and is inserted into a threaded manual crank 290. The clamp member 260 includes a fixed anti-rotation pin 280, which is inserted through aperture 285 of the clamp member 270, such that the clamp member 270 may slide laterally along the anti-rotation pin 280, but is prevented from rotating with respect to the base 30. The manual crank 290, when tightened on the pivot pin 250, compresses the two clamp members 260, 270 against the pivot platform 50 such that the pivot platform 50 is prevented from rotating with respect to the base 30. Manually loosening the crank 290 loosens the pivot platform 50, still retained around the pivot pin 250, such that the pivot platform 50 may then freely rotate around the pivot pin 250. As such, the angle of the pivot platform 50 with respect to the boom may be readily manually adjusted.

A support bracket 60 is attached to the pivot platform 50 by a pivot platform attachment which, in the preferred embodiment, includes a pair of screws 70 that retain the pivot platform 50 against an underside 200 of the support bracket 60. The support bracket 60 further includes a windscreen support mount 80 and at least one microphone support mounting arm 90.

In the preferred embodiment of the invention, one of the screws 70 is inserted into the pivot platform 50 and the support bracket 60, and is retained in a threaded screw hole 210 included on a windscreen support 120. Alternatively, each screw 70 may be inserted into the pivot platform 50 through a non-threaded screw hole 210 therein and be retained by the threaded screw hole 210 in the support bracket 60. In such an embodiment, the windscreen support mount 80 is a notched groove and the windscreen support 120 includes a tongue for laterally sliding into the groove of the windscreen support mount 80 to be retained with screws (not shown) or other suitable fasteners. In either embodiment, the support bracket 60 is firmly held against the pivot platform 50 by the screws 70.

A microphone support 100 is adapted for lockable engagement with each microphone support mounting arm 90 of the support bracket 60 (FIGS. 1 and 2), and further includes a microphone aperture 110 therethrough for receiving and frictionally retaining the microphone 5. Preferably the microphone support 100 is formed from a polymer material, such as a rubber polymer, such that physical jolts and shocks to the boom may be absorbed thereby, without being transferred to the microphone 5, thereby considerably reducing the amount of shock noise reproduced by the microphone 5. The support mount 80 preferably includes two microphone support mounting arms 90, forming an angle of between 90 and 135 degrees. The microphone support 100 likewise has two microphone support arms 105 that form generally a similar angle therebetween, such microphone support arms 105 meeting at the microphone aperture 110. In a preferred embodiment, the windscreen support 120 is formed with a tongue 300, as shown in FIG. 2. The tongue 300 is received by a groove found in the mounting arm 90 thereby providing a removable connection between the windscreen support 120 and the clamp support 20.

Further, the windscreen support 120 is adapted for lockable engagement with the windscreen support mount 80 of the support bracket 60. The windscreen support 120 includes a ring 130 with an aperture 140 at least partially therethrough. The ring 130 frictionally retains a windscreen 150, which is comprised of a generally elongated body 160 with a closed end 170 and an open end 180. The body 160 is preferably made from a reticulated foam material that significantly absorbs ambient wind noise. The body 160 further includes a microphone aperture 190 therethrough for receiving and frictionally retaining the microphone 5. When the body 160 is retained in the ring 130 of the windscreen support 150, and the windscreen support 150 is retained on the support bracket 60, the longitudinal axis of the microphone is co-aligned with the microphone aperture 110 of the microphone support 100.

A windscreen sleeve 230 is included for covering the body 160 of the windscreen 150. The sleeve 230 includes an open end 240 through which the body 160 of the windscreen 150 may be inserted and frictionally retained. The sleeve 230 is made from a pliant cloth or fur-like material to further absorb wind noise, considerably reducing the amount of wind noise reaching the microphone 5.

In use, the microphone 5 is inserted first into the microphone aperture 110 after moving the microphone support 100 out of the way. The microphone is then placed through the microphone aperture 190 of the windscreen 150, such that the end of the microphone just exits the open end 180 of the windscreen 150. The sleeve 230 is fitted around the body 160 of the windscreen 150. The pivot platform 50 is locked into a suitable position with respect to the base 30, and then the microphone is raised above the subjects to be recorded in a conventional fashion with a boom. Mechanical shocks to the boom, typically transferred to the microphone 5, are at least partially absorbed by the pliant microphone support 100 and body 160 of the windscreen 150. Further, noise generated by wind is absorbed by the sleeve 230 and the body 160.

While a particular form of the invention has been illustrated and described, it will be apparent that various modifications can be made without departing from the spirit and scope of the invention. For example, the exact number of microphone support mounting arms 90 of the support bracket 60 may be reduced to a single arm 90, or more than two arms 90, without changing the spirit and scope of the present invention. Accordingly, it is not intended that the invention be limited, except as by the appended claims.

I claim:

1. A mount for a microphone comprising:
a support bracket having at least one microphone support mounting arm;
a microphone support adapted for lockable engagement with each microphone support mounting arm, the microphone support having a microphone aperture therethrough for receiving and frictionally retaining the microphone;
a windscreen support adapted for lockable engagement with said support bracket, the windscreen support including a ring with an aperture at least partially therethrough; and;
a windscreen located on the outer surface of said windscreen support, said windscreen having a closed end and an open end, the closed end further including a microphone aperture therethrough for receiving and frictionally retaining the microphone, the microphone aperture extending from said open end to said closed end and being coaxially aligned with the microphone aperture of the microphone support, the closed end of the windscreen being supported by the ring of said windscreen support.

2. The mount of claim 1 further including a clamp support.

3. The mount of claim 2 wherein said clamp support comprises a base, a crank, and a pivot platform, the pivot platform pivotally attached to the clamp support by said crank.

4. The mount of claim 1 wherein said support bracket further includes a pivot platform and a windscreen support mount,

5. The mount of claim 1 wherein the microphone support is formed from a polymer material.

6. The mount of claim 1 wherein said mircrophone support is cylindrical.

7. The mount of claim 1 wherein said support bracket includes two microphone support mounting arms forming an angle with respect to each other of between 90 and 135 degrees.

8. The mount of claim 1 wherein the elongated body of the windscreen is comprised of reticulated foam.

9. The mount of claim 1, further including a windscreen sleeve comprised of a wind-dampening cloth material, the sleeve being open at one end thereof, whereby the windscreen sleeve may be fitted over and frictionally retained on the elongated body of the windscreen.

10. The mount of claim 9 wherein the cloth material is a fur-like material.

11. The mount of claim 9 wherein the sleeve is also open at a second end thereof.

12. The mount of claim 3 wherein the clamp support includes a threaded pivot pin, one clamp member attached to the base, another clamp member rotationally fixed with an anti-rotation pin, and a threaded manual crank for receiving the threaded pivot pin, whereby the pivot platform may be pivotably retained between the clamp members and tightened therebetween by rotation of the manual crank with respect to the pivot pin.

13. The mount of claim 1 wherein the windscreen support mount of the support bracket is a groove corresponding to a tongue of the windscreen support, whereby the windscreen support may slide laterally into the support bracket and be frictionally retained thereby.
